(19) United States
(12) Patent Application Publication
(10) Pub. No.: US 2005/0236457 A1
(43) Pub. Date: Oct. 27, 2005

(54) Nail magazine structure of a power nailer

(76) Inventor: Wen-Qing Hong, Taichung County (TW)

Correspondence Address: BACON & THOMAS, PLLC, 625 SLATERS LANE, FOURTH FLOOR, ALEXANDRIA, VA, 22314, US

(21) Appl. No.: 10/829,203

(22) Filed: Apr. 22, 2004

(51) Int. Cl. B25C 5/02

(52) U.S. Cl. 227/109; 227/120

(57) ABSTRACT

A nail magazine structure of a power nailer includes a first magazine sheet, a second magazine sheet disposed on the first magazine sheet, and a plurality of nail pushing units parallel to one another and disposed between the first magazine sheet and the second magazine sheet for pushing a row of nails disposed in the nail magazine. The nail pushing unit includes a pushing sheet, a flexible element, and a supporting portion disposed at a side of the pushing sheet for near supporting an end of the row of nails, such that the row of nails can be stably disposed in the nail magazine and be stably removed.

### FIELD OF THE INVENTION

The present invention relates to a nail magazine structure, and more particularly to a nail magazine structure of a power nailer having an interior for deposing a row of nails and including a plurality of pushing sheets for pushing the row of nails into a nailer nozzle.

### BACKGROUND OF THE INVENTION

A power nailer is the tool which shoots a nail to a work piece to be nailed by utilizing high pressure air to driving a piston and a firing pin. The power nailer mainly includes a main body, a nailer nozzle and a nail magazine. The main body is provides with the piston and the firing pin which are disposed in the main body. An end of the nailer nozzle is joined with the main body, and a side of the nailer nozzle is joined with the nail magazine. A plurality of nails are disposed in the nail magazine, and a plurality of nail pushing unit are disposed in the nail magazine for being corresponding to the nails with different length and pushing the nails into the nailer nozzle.

A typical nail pushing sheet not only provides a row of nails with pushing force but also prevents the row of nails from moving transversely so as to avoid blocking of the nail or breakdown because of slant of the row of nails. Thus, the pushing sheet is formed with a stopper surface disposed at a side thereof for preventing the row of nails from moving transversely. Referring to FIGS. 1 and 2, they depict a conventional pushing sheet 10 and a combination of the conventional pushing sheet 10 which is disposed on a magazine plate 20. The pushing sheet 10 includes a sheet body 12 and a constraining portion 14. The sheet body 12 is corresponding to a bottom surface of a row of nails 90, and the constraining portion 14 is disposed in the sliding groove 22 which is disposed in a surface of the magazine plate 20 and the constraining portion 14 is corresponding to nail heads of the row of nails 90. As described above, the structure of the above-mentioned pushing sheet 10 utilizes the sheet body 12 to provides a row of nails 90 with pushing force and utilizes the constraining portion 14 to prevent the row of nails 90 from moving transversely.

However, the constraining portion 14 must be disposed in the sliding groove 22, and the constraining portion 14 will be relative to the sliding groove 22 to be removed when the pushing sheet 10 is moved. Thus, there must be a gap between the constraining portion 14 and the sliding groove 22 to be reserved in advance for helpfully removing the pushing sheet 10. Subsequently, a gap between the constraining portion 14 and the row of nails 90 will occur, and therefore the row of nails 90 are shaken during moving. Once the row of nails 90 are slanted because of shaking and then removed into the nailer, the blocking of the nail or breakdown will occur during percussing of the firing pin. For above reason, the combination of the pushing sheet 10 and the magazine plate 20 is still required to improve.

In addition, the length of the constraining portion 14 is much shorter than the sheet body 12 and the constraining portion 14 must be corresponding to the nail heads of the row of nails 90 during operating of the combination. The constraining portion 14 with too short results in rather uneven constraining force that is acted on the row of nails 90. If the length of the constraining portion 14 is increased, the length of the sliding groove 22 must be simultaneously increased, such that the volume of the whole power nailer can be much increased and the cost of manufacture is also increased.

Accordingly, there exists a need for a nail magazine structure of a power nailer to solve the above-mentioned problems and disadvantages.

### SUMMARY OF THE INVENTION

It is an object of the present invention to provide a nail magazine structure of a power nailer having the following advantages: a row of nails which can be stably disposed and removed, and the cost of manufacture and the volume of the whole power nailer that don't be increased.

In order to achieve the foregoing objects, the present invention provides a nail magazine structure of a power nailer, characterized in that: a plurality of pushing sheets are disposed in the nail magazine, and each pushing sheet is provided with a supporting portion disposed at a side thereof for near supporting a surface of a magazine sheet and an end of a row of nails, such that the row of nails can be restricted to shake during removing and then be stably removed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a pushing sheet in the prior art.

FIG. 2 is a partially sectional schematic view showing the combination of a pushing sheet and a nail magazine in the prior art.

FIG. 3 is an exploded perspective view of a nail magazine structure of a power nailer of the present invention.

FIGS. 4 and 5 are sectional schematic views showing the combination of a nail magazine structure of a power nailer according to an embodiment of the present invention.

FIGS. 6 and 7 are sectional schematic views showing the combination of a nail magazine structure of a power nailer according to another embodiment of the present invention.

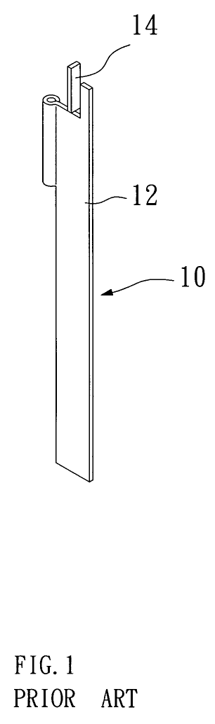

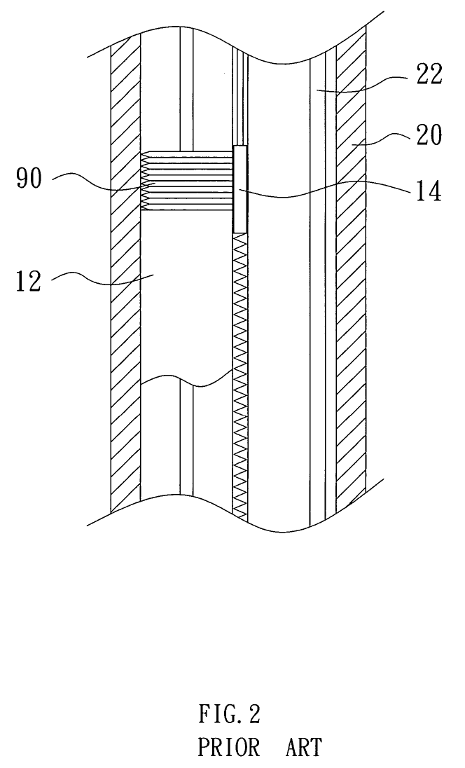

### DESCRIPTION OF THE PREFERRED EMBODIMENTS

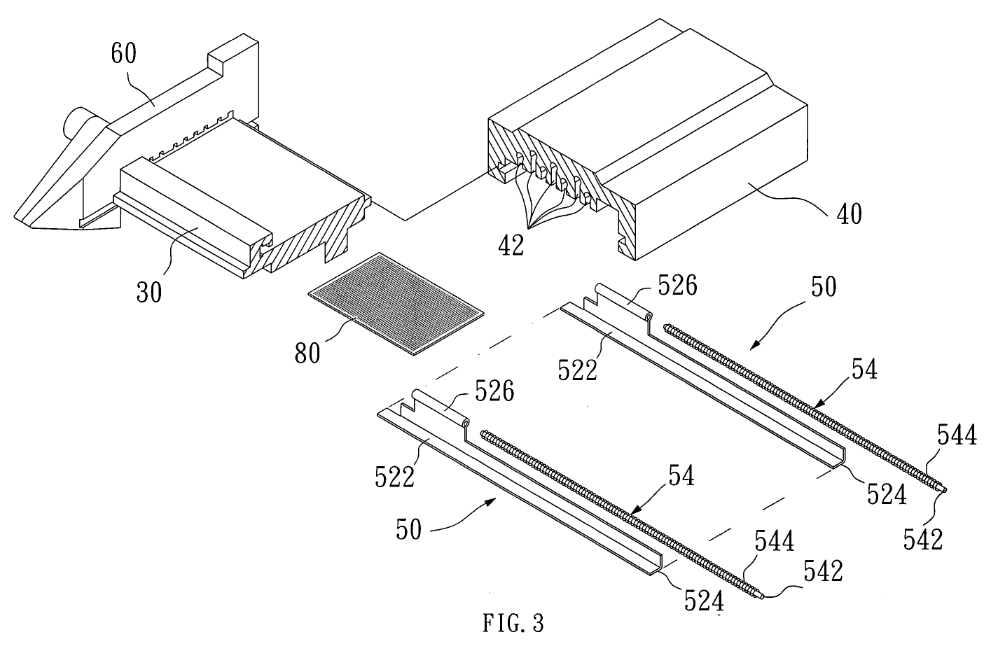

Referring to FIG. 3, it depicts a nail magazine including a first magazine sheet 30, a second magazine sheet 40, a plurality of nail pushing units 50 and a nailer nozzle 60. An end of the first magazine sheet 30 is joined with the nailer nozzle 60, and the second magazine sheet 40 is disposed on the first magazine sheet 30 and relative to the first magazine sheet 30 to move. It is noted that a surface of the first magazine sheet 30 is flat, but the second magazine sheet 40 provided with a plurality of grooves 42 disposed in a surface thereof.

The nail pushing unit 50 includes a pushing sheet 52 and a flexible element 54. The flexible element 54 is disposed in the grooves 42 of the second magazine sheet 40. The combination of the pushing sheet 52 and the flexible element 54 is disposed between the first magazine sheet 30 and the second magazine sheet 40, and the plurality of nail pushing units 50 are parallel to one another and are disposed between the first magazine sheet 30 and the second magazine sheet 40. The above-mentioned flexible element 54 can be an axial rod 542 and a spring 544 which is put around the axial rod 542.

The pushing sheet 52 is a long shape sheet body having a bending edge, and formed with a supporting portion 522 disposed at a side of the pushing sheet 52. The supporting portion 522 is provided with an expanding surface 524 which is disposed at a side thereof and perpendicular to the supporting portion 522, and the expanding surface 524 is provided with a shaft sleeve 526. It is noted that an end of the flexible element 54 is disposed at the shaft sleeve 526 and the inner diameter of the shaft sleeve 526 is longer than the outer diameter of the axial rod 542 and is shorter than the outer diameter of the spring 544, and therefore the spring 544 is compressed by utilizing an end of the shaft sleeve 526 to compress the spring 544 when the pushing sheet 52 is relative to the flexible element 54 to move.

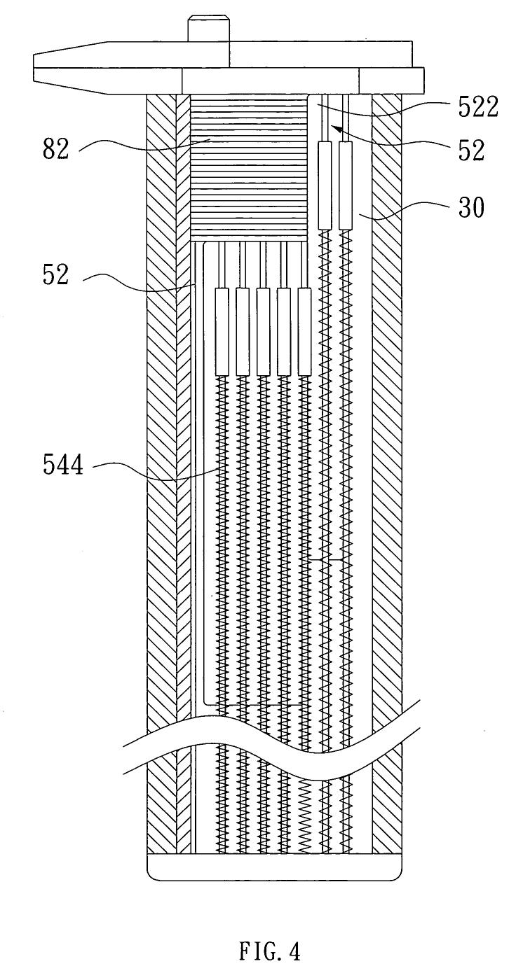

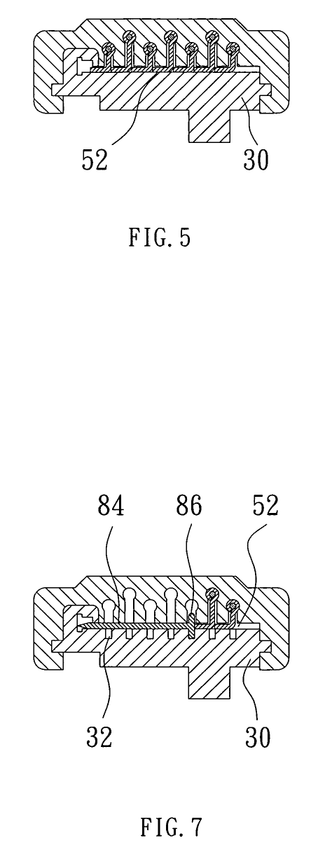

Referring to FIGS. 4 and 5, they depict that a row of nails 82 without head and the pushing sheet 52 are stably put on the flat surface of the first magazine sheet 30 according to an embodiment of the present invention. Simultaneously, the pushing sheet 52 disposed below the row of nails 82 without head is compressed by the row of nails 82 without head and further the spring 544 is compressed. Furthermore, the pushing sheet 52 disposed near an end of the row of nails 82 without head utilizes the supporting portion 522 to near support the end of the row of nails 82 without head. For above reason, the directions of the bottom and end of the row of nails 82 without head are both restricted by the pushing sheets 52. Each pushing sheet 52 near supports the end of the row of nails 82 without head, and therefore the row of nails 82 without head can be stably disposed and removed.

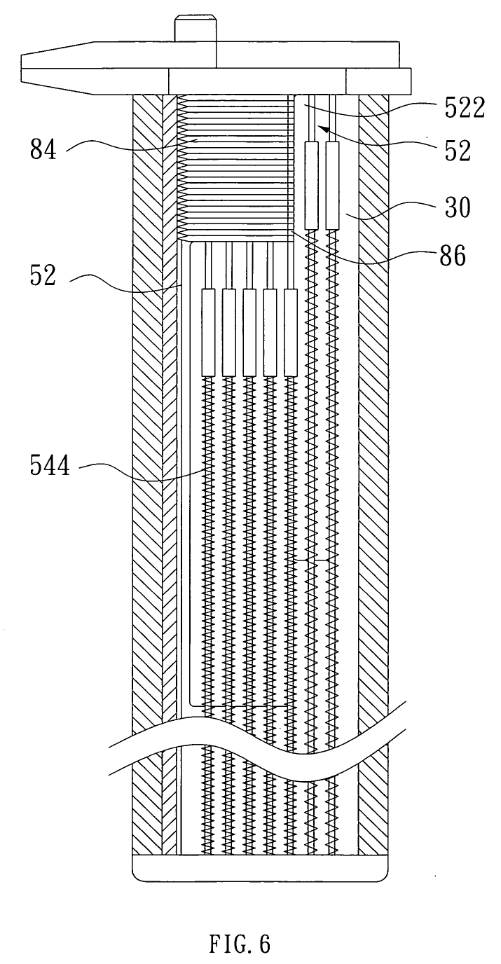

Referring to FIGS. 6 and 7, they depict that the first magazine sheet 30 is provided with a plurality of grooves 32 disposed in a surface thereof according to another embodiment of the present invention, such that heads 86 of a row of T-shaped nails 84 are snapped into the grooves 32 and the pushing sheets 52 near supports the surface of the first magazine sheet 30. Simultaneously, the pushing sheet 52 disposed below the row of T-shaped nails 84 is compressed by the row of T-shaped nails 84 and further the spring 544 is compressed. Furthermore, the pushing sheet 52 disposed near an end of the row of T-shaped nails 84 utilizes the supporting portion 522 to near support the end of the row of T-shaped nails 84. For above reason, the directions of the bottom and end of the row of T-shaped nails 84 are both restricted by the pushing sheets 52. Each pushing sheet 52 near supports the end of the row of T-shaped nails 84, and therefore the row of T-shaped nails 84 can be stably disposed and removed.

The present invention provides the pushing sheets 52 which are directly disposed on the surface of the first magazine sheet 30 and are not snapped into the first magazine sheet 30 by changing the structure of the pushing sheets 52, and therefore it can ensure that the pushing sheets 52 near support the row of nails 82, 84 so as to stably remove the row of nails 82, 84. Furthermore, the supporting portion 522 of the pushing sheet 52 has rather long length, and therefore the supporting portion 522 can provide rather even constraining force that is acted on the end of the row of nails 82, 84 for helpfully increasing the stability of the row of nails 82, 84 during removing. In addition, according to the above-mention embodiment, it is not necessary that the length of the nail magazine is increased, and therefore the cost of manufacture and the volume of the whole power nailer don't be increased.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A nail magazine structure of a power nailer having an interior for deposing a row of nails and having an end joined with a nailer nozzle, and comprising:
a first magazine sheet;
a second magazine sheet disposed on the first magazine sheet and relative to the first magazine sheet to move; and
a plurality of nail pushing units parallel to one another and disposed between the first magazine sheet and the second magazine sheet;
wherein each nail pushing unit includes a pushing sheet, a flexible element for providing flexible force to push the pushing sheet, and a supporting portion disposed at a side of the pushing sheet for near supporting an end of the row of nails.

2. The nail magazine structure of a power nailer according to claim 1, wherein the pushing sheet of the nail pushing unit is provided with a shaft sleeve for deposing an end of the flexible element.

3. The nail magazine structure of a power nailer according to claim 1, wherein the flexible element of the nail pushing unit includes an axial rod and a spring put around the axial rod.

4. The nail magazine structure of a power nailer according to claim 2, wherein the flexible element of the nail pushing unit includes an axial rod and a spring put around the axial rod.

5. The nail magazine structure of a power nailer according to claim 1, wherein the pushing sheet of the nail pushing unit is further provided with an expanding surface perpendicular to the supporting portion.

6. The nail magazine structure of a power nailer according to claim 1, wherein the second magazine sheet is provided with a plurality of first grooves for disposing the flexible elements of the nail pushing unit.

7. The nail magazine structure of a power nailer according to claim 1, wherein the second magazine sheet has a surface being flat for disposing a row of nails without head.

8. The nail magazine structure of a power nailer according to claim 1, wherein the second magazine sheet is provided with a plurality of second grooves disposed in a surface thereof for disposing a row of T-shaped nails.
